(19) United States
(12) Patent Application Publication
(10) Pub. No.: US 2007/0203616 A1
(43) Pub. Date: Aug. 30, 2007

(54) Motor vehicle control device provided with a neuronal network

(76) Inventors: Eric Borrmann, Aachen (DE); Christof Schermus, Nideggen (DE)

Correspondence Address: GIFFORD, KRASS, SPRINKLE,ANDERSON & CITKOWSKI, P.C, PO BOX 7021, TROY, MI, 48007-7021, US

(21) Appl. No.: 11/571,170

(22) PCT Filed: Jun. 24, 2005
(86) PCT No.: PCT/EP05/06830

§ 371 Date: Mar. 29, 2007

(30) Foreign Application Priority Data
Jun. 25, 2004 (DE) 10 2004 030 782.2

(51) Int. Cl. G06F 17/00

(52) U.S. Cl. 701/1

(57) ABSTRACT

A vehicle control device with a neural network is provided. The vehicle control device contains at least one backpropagation network and at least one radial basis function. The at least one backpropagation network is coupled to the at least one radial basis function for the purpose of determining a vehicle-specific characteristic diagram, The radial basis function can provide training data to the backpropagation network. The training data can include input data to and output data from the radial basis function.

### CROSS-REFERENCE TO RELATED APPLICATIONS

This application is a National Stage Application under 35 U.S.C. 371 claiming priority from International Application PCT/EP05/06830 filed Jun. 24, 2005, which claims priority of German Application 10 2004 030 782.2 filed Jun. 25, 2004.

### FIELD OF THE INVENTION

The present invention relates to a vehicle control device with one or more neural networks, as well as a method for the preparation of at least one vehicle-specific characteristic diagram.

### BACKGROUND OF THE INVENTION

The use of parameter models for forecasting operating conditions for vehicles, particularly for internal combustion engines, as well as for control, is well-known from prior art. For example, performing a method for validating parameter models of underlying parameters, wherein the parameter models are to serve for the determination of set values of operating parameters that characterize an operating mode of an internal combustion engine, is well-known from International Application Publication No. WO 01/14704 A1. A virtual torque sensor based on neural networks for implementation in motor vehicle control devices is also well-known from Patent DE 100 10 681 A1. The objective of the present invention is a simulation in a vehicle control device using a calculation model comprised of various neural networks or fuzzy systems.

### SUMMARY OF THE INVENTION

The problem of the present invention is to provide a vehicle control device with which an optimum utilization of the computational power of the control device is possible. This problem can be solved by a vehicle control device as disclosed herein. Further advantageous tasks and refinements are specified in the claims.

According to the invention, a vehicle control device is provided with a neural network wherein one or more backpropagation networks are coupled to one or more radial basis functions. Preferably one or more radial basis functions are developed as networks that precede the backpropagation network or networks. In this way, the respective advantages of backpropagation networks and radial basis function models are successfully combined, in order to be able to optimally use a vehicle control device with a typically limited computational capacity.

The radial basis function network, RBF network hereinafter, as well as the backpropagation network, are preferably constructed as forward-directed networks. Particular use is made here, as with other constellations of a coupling of the two networks, of the fact that an RBF network has only one hidden layer, for instance, but can also have several layers, while the backpropagation network likewise has only one hidden layer, for instance, but can have several hidden layers according to a refinement of the invention. One embodiment provides the RBF network with multiple layers, while the backpropagation network is preferably constructed with only one hidden layer. An output layer of the backpropagation network can preferably be chosen to be linear as well as nonlinear. This is dependent, in particular, on the requirements. Furthermore, backpropagation network computer nodes, as viewed from the neurons, can be of the same type in a hidden layer as in an output layer. In the REF network, a structure of the neurons is different in the hidden layer than in the output layer. Moreover, a hidden layer in the RBF network is not linear, whereas the output layer is linear. For the backpropagation network, both layers, hidden layer and output layer, are preferably nonlinear.

A second advantage of the coupling of the two networks results from the different activation function. While one argument for the activation function in the RBEF network is the Euclidean distance between an input vector and a respective center, an activation function for the backpropagation network can depend on the inner product of the input vector and the weighting vector of the respective neuron.

Another particularly advantageous point in the combination of backpropagation networks with RBF networks results from the fact that the backpropagation network is suitable for being able to perform an approximation in regions of an input space in which few training data, or none at all, are present. By contrast, the RBF network has a shorter training time and, in particular, reacts less sensitively to an input sequence of the training data. By virtue of the fact that the RBF network can be used for any arbitrary nonlinear transformation of an input space, the data ascertained by the RBF network can be transferred directly into the backpropagation network.

In particular, a time-critical and actual memory-critical application for the calculation of characteristic diagram data is made possible by the coupling of backpropagation network to RBF network. The thus-constructed neural network approximates a function value depending on one or more input values. In the field of vehicle technology, the function values are, for instance, a system response, that is, a reaction of a technical process of the vehicle to certain parameters of influence. In the field of internal combustion engines this can be an air mass flow as a reaction to an intake pressure, an engine speed and/or a throttle valve position.

A favorable approximation behavior of the system response is achieved after the parameters of the neural network have been suitably adapted for the system. The approximation error of the network is preferably minimized with a nonlinear optimization method. The method for this adaptation will be referred to below as training. A rather large number of input and associated output values of the process to be considered is required for the training of the neural network. Often, however, a sufficient number of such data sets is not available metrologically at a reasonable cost. By coupling one or more RBF-networks to one or more backpropagation networks, however, it becomes possible to supplement the database for the training of the neural network or networks from a small number of observation values. It is preferably assumed in this case that the data can be ascertained due to an overall smooth system response. In this connection, the word “smooth” means that the system response has no or few inflection points between observation points as well as outside the observation points. In this manner, the advantage of an RBF network, being able to approximate smooth system responses on the basis of few training data, can be combined with the advantage of the backpropagation network, creating a high approximation quality.

It is preferred that the RBF network be directly coupled to the backpropagation network. In this case, no additional data-modifying element is inserted between the two networks. The speed of the REF network allows the immediate inflow of the data ascertained in the RBF network into the coupled backpropagation network for approximation by means of the neural network. One or more feedbacks between, for example, the RBF network and the backpropagation network, as well as between the neural network and the RBEF network, can be provided in this case.

According to one embodiment, the neural network is constructed such that already available input and output data are supplemented by virtual learning data as learning data for the training of the backpropagation network as well as, to a limited extent, outside the latter. The virtual learning data are ascertained via one or more REF networks and are transferred to the backpropagation network. In this manner, data created can be transferred to the backpropagation network only via the RBF network. In another embodiment, it is provided that the data transferred via the RBF network to the backpropagation network are supplemented by the original data, which are likewise transferred to the backpropagation network.

One advantage of this procedure is that a markedly reduced number of measurement data is required for training the backpropagation network by a supplementation with virtual learning data. The method makes particular use of the capability of RBF networks for the approximation of smooth system responses, circumventing at the same time, by using backpropagation networks, their high requirements for computational power and memory space of the real-time system.

On the basis of an example of a sinusoidal function in the value range 0 to 2π, a potential savings of computer power for a two-stage coupled application of RBF network and baclkpropagation network is shown by the following. For successful training of a backpropagation network with three neurons in a hidden layer, at least twelve samples of the sinusoidal function are required, plus further validation data. According to a rule that 50% of the available data can be used for the training, while the rest is to be left for validation, this implies a requirement of 24 value pairs. In the present invention, the backpropagation network achieves excellent precision with significantly less samples. An RBF network achieves sufficient precision with seven samples as training data, good precision with ten, with the necessity again of adding in the validation data. Such an RBF network can be used to add an arbitrary number of intermediate values to the seven to ten base values in the training data set. This expanded training data set is subsequently used for the adaptation of the parameters of the backpropagation network. Depending on the number of intermediate values and the approximation quality of the RBF network, the precision of a backpropagation network trained in this way can be comparable to that of a network that is trained with a substantially larger number of pure measurement data.

The scope of experimental investigations can be reduced by coupling RBF networks to backpropagation networks. Experimental savings as well as test savings can result from the lower number of experimentally ascertained data sets. In addition, there is the possibility of generating additional training data on the basis of already available measurement data. In this manner, the approximation quality of a backpropagation network used in a control algorithm can be improved. In particular, the neural network can be used for real-time systems, as well as for simulations. With such a neural network, there is also the possibility of generating vehicle-specific characteristic diagrams, storing them on a data medium and using it in, for instance, a simulation, or recording them in a vehicle control device during a simulation. Such a method can also be stored on a data medium and copied into a vehicle control device. There is the possibility, in particular, of usage in real-time systems and/or in diagnosis systems as well.

Preferred applications of the above-described method or velocity control device are, for example:

a) Use in an engine control device. In this case, input and output signals of the control device can be coupled to one another via one or more neural networks. Such signals are, for instance, an engine speed, a crank shaft position, a throttle valve angle, an accelerator pedal position, an air mass flow, an intake pipe pressure, residual exhaust gas oxygen (lambda value), an engine temperature, an oil temperature, an air pressure, an air temperature, a knocking tendency, an exhaust gas recirculation, an intake air supercharge, a tank ventilation, an ignition timing, an injection amount, an injection timing, valve opening and closing timing and other possible input and output signals. This list is only for the sake of example, without being exhaustive. Additional parameters can be represented and adapted, alongside these actuation, control and regulation variables. On the basis of models, these can also be system properties such as friction power, heat losses, fuel quality and evaporation properties, combustion chamber integrity or others. These as well as other values can be ascertained or regulated not only in the engine control device, but via other control devices as a well. The engine control device is preferably connected to one or more control devices and has an exchange of data. The exchanging of data preferably takes place on an analog or digital basis via, for instance, a CAN bus and/or via a MOST connection.

b) Use in a vehicle-specific control device. According to a first configuration, a control device for at least one valve train has the above-described neural network. According to a second configuration, a control device affecting fuel injection has such a neural network. According to a third configuration, a control device affecting an exhaust behavior of a vehicle has such a neural network. According to a fourth configuration, a control device affecting a safety device has such an above-described neural network. The safety device is preferably controlled, regulated and/or initiated with the control device. For example, the control device can control a vehicle position. The latter is possible, for instance, with an ESP system. Additional safety devices can be: airbags, light control, brakes, tire monitoring, oil supply, inter-vehicle distance regulators, yawing behavior of the vehicle, ABS systems, emergency systems, particularly run flat systems, fire protection systems, cooling systems or similar.

c) Use in a simulator and/or test device. This can be a stationary or a mobile device. Simulation is done with, for instance, a data set obtained via initial tests, characterizing special driving ranges, stresses and/or requirement profiles. By first processing such a data set with the RBF network, the amount of data is increased, preferably by at least a factor of 3. With this data, the backpropagation network then generates the characteristic diagram. The latter can be subsequently tested and evaluated and improved with parameters obtained thereby.

A vehicle control device with the above-described neural network is preferably used for regulation of one or more parameters or devices relating to the vehicle. The vehicle control device can also be used for controlling them.

The neural network to be employed can preferably be coupled to other neural networks or fuzzy models. Possible couplings can be undertaken with neuronal model structures of the type disclosed in DE 100 10 681 A1. In that regard the latter publication is incorporated in full by reference in the scope of the present disclosure.

It is particularly advantageous in using the above-described neural network if one works with up to ten neurons with respect to the RBF network. Exact, i.e., interpolating RBFs can require considerably more than ten neurons, however, if each measurement point is occupied by a neuron. The cost of the calculation may then be greater than that of backpropagation networks. Approximation RBF networks, on the other hand, can be designed to have fewer neurons and thus represent an alternative to approximating baclkpropagation networks, according to one refinement of the invention. In particular, there is the possibility of providing within the testing plan a test space that furnishes partially correlated data and/or non-orthogonal spaces. In particular, the above-described neural network permits the provision of multilinear interpolarities, which may not be continuously differentiable at the measurement points. According to one refinement, an adaptive component design is provided by using the neural network.

According to another design, it is provided that a multilayer perception (MLP) network is furnished with backpropagation learning. According to another configuration, the usage of a baclkpropagation through time network (BPtT) is provided. In addition to the use of a single-layer or multilayer feed-forward network, one or more recursive neural networks with or without intrinsic feedback can likewise be provided. In particular, the neural network can also have a lattice network structure, in which a one, two or three-dimensional arrangement of neurons with an associated set of nodes pass the input signals along to this arrangement. In particular, this can be done in the form of self-organizing maps (SOM).

In place of a backpropagation function and RBF, it is possible, according to another idea of the invention, to use other approximating or interpolating methods such as LOLIMOT, SOM or spline interpolation, if appropriate. The latter is used particularly if an input space has a limited multidimensionality, so that calculation time is roughly comparable to that for an approximating neural network.

The present invention thus concerns a vehicle control device with a neural network, wherein one or more back propagation networks are coupled to one or more radial basis functions. Furthermore, a method is provided for the preparation of at least one vehicle-specific characteristic diagram, wherein a plurality of input data is processed by means of a neural network via one or more radial basis functions that are coupled to one or more backpropagation networks, and is converted to a characteristic diagram.

### BRIEF DESCRIPTION OF THE DRAWINGS

Additional advantageous configurations and refinements are described in greater detail in the following drawings. The embodiments represented there are not to be construed as limiting, however. Rather, the characteristics described can be linked alone or in combination with the characteristics described above to form further configurations. Shown are:

FIG. 1, an example of a neural network,

FIG. 2, a parallel connection of control devices with neural networks, and

FIG. 3, an application of the neural network.

### DETAILED DESCRIPTION OF THE INVENTION

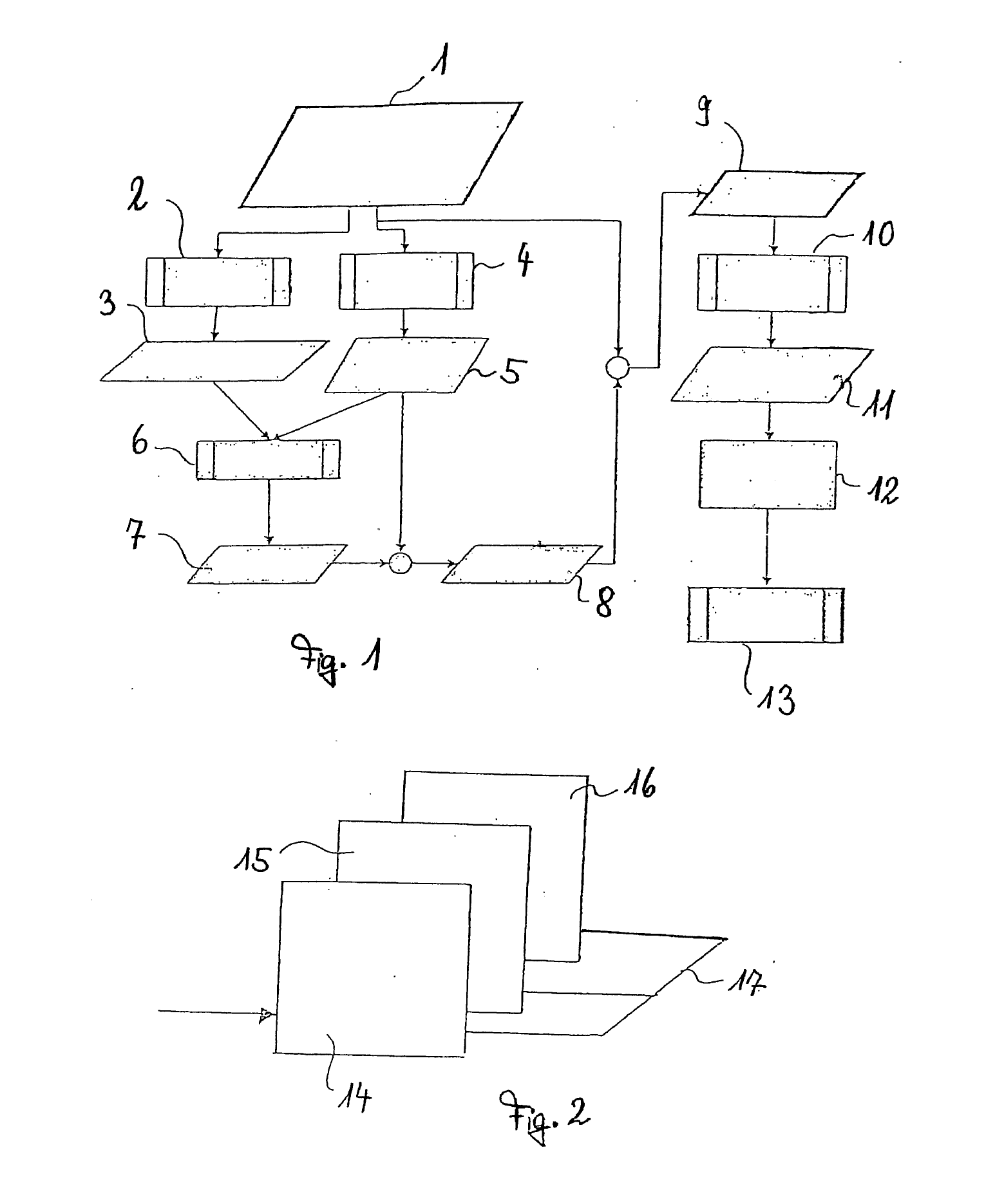

FIG. 1 shows an example of the structure of a neural network as it preferably exists integrated in a motor vehicle control device. Original data are preferably specified, but can also be generated. They can be supplied to the control device via sensors. Original data 1 have in particular a data set consisting of several measurements of one or more output parameters of a system and the associated input parameters. This system behavior is to be subsequently approximated by a backpropagation network. In a predefined process 2, an RBF networks is first trained on the basis of these original data. The parameters of the RBF model are subsequently present as a data set 3. In a process 4 running parallel to the RBEF training, the input space described by original data 1 is simultaneously checked with regard to sufficient covering for excitation of the backpropagation network that is to be trained later, and additional virtual input data 5 are determined.

These virtual input data 5 are used with application of data set 3 of the REF network parameters in process 6, in order to generate a virtual system output or a virtual system response 7. This virtual system response, 7, together with virtual input data 5, yields the virtual system behavior 8. Virtual system behavior 8, combined with original data 1, in turn yields expanded training data 9. Expanded training data 9 are used for training backpropagation network 10. This results in a backpropagation network model 11 for calculating the system response to an arbitrary combination of input parameters. A control device implementation 12 can be done with this backpropagation network model 11. A model-based regulation 13 of, for instance, an internal combustion engine is done via control device implementation 12. In this manner as well as in others, an RBF network is thus inserted upstream of a backpropagation network. In particular, a multidimensional look-up and interpolation of characteristic diagram points can thereby be replaced by a continuous mathematical approximation, i.e., by the output of an MLP. Excitation sufficient for the training of the MLP can be achieved by supplementation of the input and output space by means of virtual input data and virtual system response.

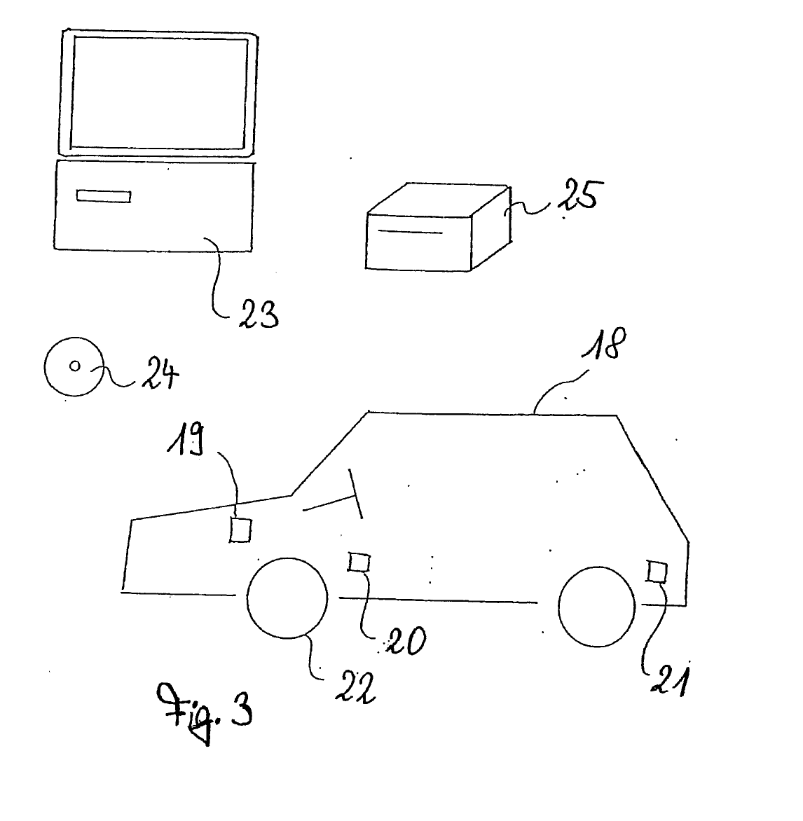

FIG. 2 shows a configuration in which several control devices 14, 15, 16 are connected in parallel to one another via a bus system 17. This connection permits a neural network to draw not only on one control device 4, but on a plurality of control devices 14, 15, 16 and to execute computational operations in parallel. In this manner, real-time-based regulation exploiting the available computational capacity of a vehicle can be improved. Identical neural networks or different ones equipped with the same types of components can be coupled to one another here.

FIG. 3 shows in a schematic view a possible use of a method for preparing at least one vehicle-specific characteristic diagram, or a use of a vehicle control device with a neural network, as well as a use of a data medium with a program for preparing a simulation for a vehicle or for copying into a vehicle control device. The schematically indicated vehicle here can stand for a movable vehicle that is in use. However, it can also stand for a stationary test stand, in particular, a stationary test stand or diagnosis stand. In a vehicle 18, an engine control device 19, a vehicle position monitoring control device 20 and a vehicle distance monitoring control device 21 are shown. For instance, a lateral distance from adjacent vehicles is monitored with distance monitoring control device 21. A forward or backward distance from vehicles or from objects above can also be monitored. With vehicle position monitoring control device 20, for instance, a drive train and/or a yaw effect and/or a rotary behavior of wheels 22 is monitored and, in particular, regulated. Engine control device 19 monitors and regulates, in particular, an internal combustion engine as well as associated assemblies and exhaust components such as a filter or catalytic converter. Control devices 20, 21, 22 are preferably networked to one another, and each has at least one neural network for monitoring, but particularly for controlling and/or regulating components on the vehicle. The data sets necessary for the respective components can be recorded by experiment, for instance, and processed into characteristic diagrams generated by computer 23. These characteristic diagrams can be stored on a data medium 24, for example. Data medium 24 can be, for example, a CD-ROM, a DVD, a diskette, a hard drive or some other type of storage medium such as a memory chip. Data medium 24 is preferably brought into connection with an additional schematically represented vehicle control device 25, wherein the data present on the data medium as well as on one or more programs can be copied onto vehicle control device 25. In this manner, novel neural networks for improved real-time calculation, for instance, particularly for regulation of vehicle components, can be retrofitted into existing vehicle control devices. This is also possible by exchanging a corresponding chip set housed in the vehicle control device. Conversely, there again exists the possibility that test runs may be conducted with the vehicle 18, in which case corresponding data to be recorded via such data media are collected via vehicle control devices 19, 20, 21. These concretely obtained data are stored via data medium 24 and further evaluated via computer 23 and extended with additional virtually obtained data. This can be carried out, in particular, according to the method presented in FIG. 1.

According to another idea of the invention, additional application possibilities result everywhere a closed connection is to be represented based on few variants by a smooth, “flat” mathematical backpropagation model, in particular, an MLP-based model. The method for coupling RBF and MLP can also be envisioned separately from the implementation in a control device.

Examples of this are the control and regulation of jet propulsion, flying position and climate control in the aviation industry; control of traffic lights, speed limits, passing prohibitions and permanent lighted signs for improving traffic flow in traffic engineering; adaptive control of building heating, burners, solar-thermal systems, for instance, in the housing and climate control industry; monitoring of quality characteristics in the production process in the metal-working industry, for instance, the control of welding current and feeding in welding joining technology and of material characteristics of alloys; in the chemical industry, for instance, an optimization of formulations and regulation of mixing processes and thermal state parameters in reactors, as well as of material flows for variable material properties; and in agriculture, for example, an optimization of the cultivation yield as well as a regulation of climate control, irrigation and fertilizing in breeding facilities and greenhouses.

We claim:

1-24. (canceled)

25. A vehicle control device with a neural network comprising:
at least one backpropagation network; and
at least one radial basis function;
said at least one backpropagation network coupled to said at least one radial basis function.

26. The invention of claim 25, wherein said neural network comprises said at least one radial basis function, for the purpose of training said at least one backpropagation network.

27. The invention of claim 25, wherein said at least one radial basis function is directly coupled to said at least one backpropagation network.

28. The invention of claim 25, wherein said neural network is operable in a real-time system.

29. The invention of claim 25, wherein said at least one backpropagation network receives training data from said at least one radial basis function.

30. The invention of claim 26, wherein said at least one backpropagation network receives input data to and training data from said at least one radial basis function.

31. The invention of claim 30, wherein training data for training said at least one backpropagation network includes input data to and output data from said at least one radial basis function.

32. The invention of claim 31, wherein said at least one radial basis function provides virtual data to said at least one backpropagation network.

33. The invention of claim 32, wherein said at least one backpropagation network is directly coupled to said at least one radial basis function.

34. The invention of claim 25, wherein said vehicle control device is an application control device.

35. The invention of claim 34, wherein said application control device is an engine control device.

36. The invention of claim 35, wherein said engine control device affects at least one valve train.

37. The invention of claim 35, wherein said engine control device affects a fuel injection system.

38. The invention of claim 35, wherein said engine control device affects an exhaust behavior.

39. The invention of claim 25, wherein said vehicle control device controls a safety device.

40. The invention of claim 25, wherein said vehicle control device controls a vehicle position.

41. The invention of claim 25, further comprising more than one interconnected vehicle control devices, for the purpose of data exchange and computation of characteristic diagram data for the vehicle.

42. The invention of claim 41, wherein said more than one vehicle control devices are connected in parallel.

43. The invention of claim 25, wherein said vehicle control device is a component of a stationary test stand.

44. The invention of claim 25, wherein said vehicle control device is a component of a stationary engine test stand.

45. The invention of claim 41, further comprising a data medium, said data medium storing said characteristic diagram data, for the purpose of copying said characteristic diagram data onto a different vehicle control device.

46. A method for the production of at least one vehicle-specific characteristic diagram, comprising;
providing at least one radial basis function operable to provide input data;
providing at least one backpropagation network operable to accept the input data;
coupling the at least one radial basis function to the least one backpropagation network for the purpose of processing the input data into at least one vehicle-specific characteristic diagram.

47. The method of claim 46, wherein the at least one radial basis function provides the input data to the at least one backpropagation network, for the purpose of training the at least one backpropagation network.

48. The method of claim 46, further comprising providing a neural network, the neural network simulating the conditions of a vehicle by computation.

49. The method of claim 48, wherein the neural network computes simulated vehicle conditions.

50. The method of claim 48, wherein the neural network simulates data for a vehicle.

51. The method of claim 48, wherein the neural network provides training data for a vehicle control device.

52. The method of claim 46, further comprising providing a control device, the control device producing the at least one vehicle-specific characteristic diagram.

53. The invention of claim 46, wherein the production of at least one vehicle-specific characteristic diagram is used for the diagnosis of at least a part of a vehicle.
